(19) United States
(12) Patent Application Publication
(10) Pub. No.: US 2009/0197043 A1
(43) Pub. Date: Aug. 6, 2009

(54) Flat Sheet for Receiving a Printed Pattern, Process for Producing Same, and Use Thereof

(75) Inventors: Karl Dennler, Herisau (CH); Noemi Rohner, Rheineck (CH)

Correspondence Address: BACHMAN & LAPOINTE, P.C., 900 CHAPEL STREET, SUITE 1201, NEW HAVEN, CT, 06510, US

(73) Assignee: SEFAR AG, Thal/SG (CH)

(21) Appl. No.: 12/418,641

(22) Filed: Apr. 6, 2009

Related U.S. Application Data
(62) Division of application No. 11/578,847, filed on Oct. 18, 2006.

(30) Foreign Application Priority Data
Apr. 19, 2004 (DE) 10 2004 019 398.3
May 29, 2004 (DE) 10 2004 026 445.7
Dec. 13, 2004 (DE) 10 2004 060 105.4

(51) Int. Cl. B32B 3/10

(52) U.S. Cl. 428/137

(57) ABSTRACT

In a sheet with openings which is designed to receive a printed pattern on one of its surfaces, a fabric woven from crossed threads, more particularly synthetic filaments, has different coloring on each surface with the printed pattern on the lighter surface. More particularly the woven fabric is a monofilament or multifilament synthetic woven fabric which either is made of black threads or is dyed black and is colored white on one surface. The threads are crimped at the same level and the lighter surface has a high degree of whiteness.

### CROSS REFERENCE TO RELATED APPLICATIONS

This application is the divisional of U.S. patent application Ser. No. 11/578,847, filed Oct. 18, 2006 which is a U.S. national phase of International Application No. PCT/EP2005/004023 filed Apr. 15, 2005 which claims priority of German Application No. 10 2004 019 398.3 filed Apr. 19, 2004, German Application No. 10 2004 026 445.7 filed May 29, 2004 and German Application No. 10 2004 060 105.4 filed Dec. 13, 2004.

### BACKGROUND OF THE INVENTION

The invention relates to a flat sheet for receiving a printed pattern. In addition, the invention covers a process for producing said sheet and the use thereof.

On the market it is possible to obtain printing substrates of perforated films and papers which are white on the front side and black on the back; the white side is printed. If the printing substrate is mounted on a window pane or a corresponding transparent surface element, the print is visible in two dimensions from outside but, from the inside, the viewer is able to look outside through the black surface; the printed pattern present on the white front side remains invisible to him. Thanks to this concept, large advertising areas can be created which, firstly, are transparent from the inside and, secondly, grant protection against the sun and offer good protection against being seen. By means of the black rear surface, the view of an observer is concentrated on the processes on the other side of the surface—assuming a brighter external environment. The printing of the advertising surface—therefore one-way transparent—can be carried out with all printing processes, for example by screen printing.

Approximately since the 19th century—centuries after a first application in China—screen printing processes have been known in Europe; a receiving surface is clamped in a screen printing frame and, in the image-free regions, is covered by a stencil so as to be impermeable to ink. Apart from manually cut stencils, for example for labels, nowadays photographically produced direct or indirect stencils are preferably usual; the choice of the type of stencil—in the case of direct stencils those with emulsion, with direct film and emulsion or with direct film and water—is left up to the screen printer.

WO 99/065680 additionally describes a graphic multicomponent subject having components that can be imaged, the latter containing an upper, perforated polymer film layer that can be imaged, having a first main surface that can be imaged and a second main surface, an opaque, light-absorbing, perforated polymer film layer, which is applied to the second main surface of the film layer that can be imaged, and also a fixing component, which comprises a substantially transparent scrim layer having a first main surface and a second main surface; a contact adhesive layer is applied to the first main surface and a layer of a heat-activated adhesive is applied to the second main surface in order to have the fixing component adhere to an image layer, which has been formed by imaging the film layer that can be imaged on its first main surface.

U.S. Pat. No. 6,004,649 discloses a flat sheet comprising a net-like structure, in which the entire surface of a substrate is coated with white ink and a black ink is sprayed onto the rear, and a multicolored ink is applied to a front side by printing. A completely white coloration and the application of at least three colored layers prove to be disadvantageous.

In the knowledge of these given facts, the inventor has set the object of providing an improvement for such a sheet mentioned at the beginning, in particular a novel application.

### SUMMARY OF THE INVENTION

The foregoing object is achieved in accordance with the present invention by providing a flat sheet having two surfaces and having apertures for receiving a printed pattern on one of the two surfaces, a fabric web woven from crossing threads is provided on both surface sides with different coloring and, on its lighter surface side, is finished with the printed pattern, characterized in that the fabric web is woven with black threads and, in order to form the lighter surface side, is provided with a white ink on one surface side, or in that the fabric web is formed as a synthetic fabric, which is colored black and, in order to form the lighter surface side, is provided with a white ink on one surface side. In addition, the scope of the invention includes all combinations of at least two of the features disclosed in the description and the drawings. In the case of specified dimension ranges, the intention is for values lying within the aforementioned limits also to be disclosed and to be capable of use as desired.

According to the invention, a fabric web woven from crossing threads, in particular from plastic filaments, is provided on both surfaces sides with different coloring and, on its lighter surface side, is finished with the printed pattern; this surface is therefore one-way transparent. The printed pattern can be applied over the entire area or partially and also comprise image reproductions and/or parts of script, the latter for example for an advertising design.

The sheet according to the invention is preferably a monofilament synthetic fabric, but a multifilament synthetic fabric can also be used. The synthetic fabric is woven precisely, then colored as intensely as possible in black and its at least one surface is subsequently flattened by means of special calendering—preferably by means of hot and cold rolls at a defined temperature, defined speed and temperature—in order to obtain a larger thread surface and—for the purpose of an improved printed image build-up—to obtain thread knuckles located at the same height. To this end, it is also possible to reduce the thickness of the fabric web.

In addition, it is of inventive importance that, if appropriate, specific threads having a fusible sheath are used; after the weaving operation, the thread knuckles are melted here. In this way, fraying can be reduced or even eliminated entirely.

According to the invention, for the calendering operation, hot rolls are primarily used on the side to be printed and cold rolls are used on the side remaining black; the cold roll has the effect that the rear is flattened little or not flattened, which means that the textile appearance is maintained and the transparency remains optimal.

According to a further feature of the invention, a white special ink having the highest possible whiteness is applied to one side; the various ink systems such as UV, solvent and water-based inks used by the printer for the advertising design must adhere satisfactorily to this white ink.

According to the invention, the fabric web can also be produced entirely with black threads and one surface can then be coated with that white ink.

The scope of the invention also includes the use of the sheet described above as an advertising sheet printed on one side, this in particular in front of a transparent background, for example on the inside of a glass pane. This lightweight advertising sheet is—as stated—transparent on one side and reusable.

### BRIEF DESCRIPTION OF THE DRAWINGS

Further advantages, features and details of the invention emerge from the following description of preferred exemplary embodiments and by using the drawing; in the latter:

FIGS. 1, 2 each show a plan view of one of the surfaces of a web-like surface element.

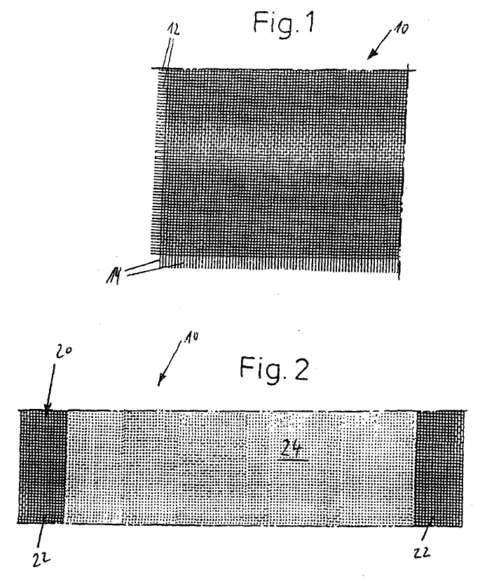

### DETAILED DESCRIPTION

A fabric web 10 is woven in the manner of a net from crossing black threads 12, 14, which delimit network interspaces 16 of approximately square shape. These threads 12, 14 are in particular plastic filaments of a monofilament or multifilament synthetic fabric and are produced from black material or colored black.

The threads 12, 14 determine a dark surface 18; the other surface 20 is provided with a white colored layer 24 of high whiteness, which in FIG. 2 is delimited on both sides by black network regions 22 of the surface 20.

The fact that the colored layer 24 is used as a supporting surface for an image reproduction is not illustrated.

1-25. (canceled)

26. A flat sheet comprising two surfaces (18, 20) and having apertures (16) for receiving a printed pattern on one of the two surfaces (18, 20), a fabric web (10) woven from crossing threads (12, 14) comprising plastic filaments is provided on both surfaces (18, 20) with different coloring to form a lighter surface side and a darker surface side, wherein the lighter surface side (20) receives the printed pattern.

27. The flat sheet as claimed in claim 26, wherein the darker surface side receives a monofilament synthetic fabric (10) which is colored black and is provided with a white ink (24).

28. The flat sheet as claimed in claim 26, wherein at least one of the surface side receives a multifilament synthetic fabric (10) which is colored black and is provided with a white ink (24).

29. The flat sheet as claimed in claim 26, wherein the fabric web (10) is woven with black threads (12, 14) and is provided with a white ink (24) on at least one surface side (20).

30. The flat sheet as claimed in one of claims 27 to 29, wherein the ink (24) on the light surface side has a high whiteness.

31. The flat sheet as claimed in claim 27, wherein both surfaces are characterized by equally high thread crimping.

32. The flat sheet as claimed in claim 27, wherein the threads (12, 14) have a fusible sheath.
